(19) United States
(12) Patent Application Publication
(10) Pub. No.: US 2014/0290702 A1
(43) Pub. Date: Oct. 2, 2014

(54) METHOD FOR CLEANING COMPONENTS OF NITRIDE SEMICONDUCTOR MANUFACTURING APPARATUS AND DEVICE FOR CLEANING COMPONENTS OF NITRIDE SEMICONDUCTOR MANUFACTURING APPARATUS

(71) Applicant: TAIYO NIPPON SANSO CORPORATION, Tokyo (JP)

(72) Inventors: Tadanobu Arimura, Tsukuba-shi (JP); Toshiya Tabuchi, Tsukuba-shi (JP)

(21) Appl. No.: 14/344,004

(22) PCT Filed: Sep. 25, 2012
(86) PCT No.: PCT/JP2012/074536

§ 371 Date: Mar. 10, 2014

(30) Foreign Application Priority Data
Sep. 27, 2011 (JP) 2011-210423

(51) Int. Cl. B08B 7/00

(52) U.S. Cl. CPC B08B 7/0021
USPC 134/30; 134/95.3

(57) ABSTRACT

A method for cleaning a component of a nitride semiconductor manufacturing apparatus to which has adhered deposits containing nitride semiconductor comprises a step for chemically treating the component of the nitride semiconductor manufacturing apparatus with a cleaning gas containing a chlorine-based gas, and a step for removing the deposits from the component of the nitride semiconductor manufacturing apparatus by spraying with a sublimable solid substance.

### TECHNICAL FIELD

The present invention relates to a method for cleaning components of a nitride semiconductor manufacturing apparatus and a device for cleaning components of a nitride semiconductor manufacturing apparatus.

The present application claims priority on the basis of Japanese Patent Application No. 2011-210423, filed in Japan on Sep. 27, 2011, the contents of which are incorporated herein by reference.

### BACKGROUND ART

In nitride semiconductor manufacturing apparatuses for forming nitride semiconductor films, nitride semiconductor films are manufactured by growing raw materials of nitride semiconductor films in the form of gallium nitride, aluminum nitride, indium nitride and nitride crystals of a plurality of metals on a wafer.

At this time, in the nitride semiconductor film growth process, deposits in the form of a nitride semiconductor film or substances formed as a result of the aforementioned film not being grown end up accumulating on the surface of components of the nitride semiconductor manufacturing apparatus (and more specifically, components of the gas flow path) that compose the nitride semiconductor manufacturing apparatus.

Substances formed as a result of the aforementioned film not being grown may include substances such as carbon or metal oxides or may include compounds of carbon or metal oxides. Carbon is formed as a result of decomposition of organometallic raw materials used as raw materials of nitride semiconductor films.

In addition, metal oxides are formed by a reaction between metal that has decomposed from organometallic materials (such as Ga, In, Al or Mg) and oxygen derived from materials of components of the nitride semiconductor manufacturing apparatus (such as quartz (SiO₂)).

Deposits that have accumulated (adhered) on components of a nitride semiconductor manufacturing apparatus are present in the form of particles, and in terms of forming a high-quality nitride semiconductor film, not only hinder crystal growth, but also lower the quality of the nitride semiconductor film by being incorporated in the nitride semiconductor film as impurities.

Consequently, it is necessary to remove deposits that have accumulated on components of a nitride semiconductor manufacturing apparatus by cleaning in a stage prior to growing the nitride semiconductor film.

In the past, methods used to clean deposits adhered to the components of nitride semiconductor manufacturing apparatuses consisted of, for example, cleaning by heat reduction using hydrogen or cleaning using hot concentrated phosphoric acid.

However, in the case of removing deposits adhered to the components of nitride semiconductor manufacturing apparatuses by cleaning by heat reduction using hydrogen, since cleaning is carried out at a high temperature, there was the problem of deformation of components of the nitride semiconductor manufacturing apparatus.

In addition, in the case of removing deposits adhered to the components of nitride semiconductor manufacturing apparatuses by cleaning using hot concentrated phosphoric acid, since cleaning is carried out at a high temperature and highly toxic vapors are generated, it was difficult to adequately ensure safety during cleaning work.

Therefore, deposits adhered to the components of nitride semiconductor manufacturing apparatuses are removed by a dry cleaning method that uses a halogen-based gas such as chlorine gas or hydrogen chloride as a cleaning method capable of preventing deformation of components of nitride semiconductor manufacturing apparatuses and adequately ensuring safety during cleaning work (see, for example, Patent Documents 1 and 2).

However, there is also a method for removing deposits by physical impact by spraying a fine solid substance such as alumina in the manner of sandblasting onto components of a nitride semiconductor manufacturing apparatus to which deposits have adhered.

However, since components of nitride semiconductor manufacturing apparatuses composed of a material such as quartz undergo considerable wear, application of the aforementioned sandblasting method resulted in the problem of excessive wear of the components of nitride semiconductor manufacturing apparatuses.

In addition, Patent Document 3 discloses a cleaning device provided with a first flow path through which a first gaseous substance flows, a second flow path through which an inert gas flows, a junction where the first gaseous substance flowing through the first flow path and the inert gas flowing through the second flow path merge, and a nozzle for spraying particles of a first solid substance (dry ice) formed as a result of that merging in the junction.

However, according to the methods described in Patent Documents 1 and 2, in the case of cleaning deposits containing components having high activation energy in the manner of aluminum nitride or deposits that have adhered to the surface of a component of a nitride semiconductor manufacturing apparatus that has become roughened due to repeated use, there were the problems of poor cleaning efficiency and deposits remaining on the surface of the components of nitride semiconductor manufacturing apparatuses.

In addition, in the case of using the method described in Patent Document 3, since deposits are strongly adhered to the surface of components of nitride semiconductor manufacturing apparatuses, there was the problem of hardly any of these deposits being able to be removed from the surface of components of nitride semiconductor manufacturing apparatuses.

### DOCUMENT OF RELATED ART

### Patent Documents

[Patent Document 1] Japanese Unexamined Patent Application, First Publication No. 2006-332201

[Patent Document 2] Japanese Unexamined Patent Application, First Publication No. 2007-109928

[Patent Document 3] Japanese Unexamined Patent Application, First Publication No. 2004-89944

### SUMMARY OF INVENTION

### Technical Problem

An object of the present invention is to provide a method for cleaning components of a nitride semiconductor manufacturing apparatus, and a device for cleaning components of a nitride semiconductor manufacturing apparatus, capable of removing deposits adhered to the surface of components of nitride semiconductor manufacturing apparatus while suppressing damage to the surface of components of a nitride semiconductor manufacturing apparatus within a range that sufficiently allows the components of the nitride semiconductor manufacturing apparatus to be reused.

### Solution to Problem

(1) In order to solve the aforementioned problems, a first aspect of the present invention provides a method for cleaning a component of a nitride semiconductor manufacturing apparatus to which has adhered deposits containing nitride semiconductor, comprising: a step for chemically treating the component of the nitride semiconductor manufacturing apparatus with a cleaning gas containing a chlorine-based gas, and a step for removing the deposits from the component of the nitride semiconductor manufacturing apparatus by spraying with a sublimable solid substance.

(2) In (1) above, a mixed gas comprised of a mixture of at least one type of chlorine-based gas among chlorine, hydrogen chloride and boron trichloride, and at least one type of diluent gas among nitrogen, argon, helium and air, is preferably used for the cleaning gas.

(3) In (1) or (2) above, the treatment temperature of the aforementioned chemical treatment is preferably within the range of 500° C. to 1000° C.

(4) In (3) above, a component having low activation energy among the deposit components is preferably removed in the chemical treatment step.

(5) In any of (1) to (4) above, the sublimable solid substance preferably at least contains carbon dioxide.

(6) In (5) above, the sublimable solid substance is preferably dry ice.

(7) In any of (1) to (6) above, a gas flow path component is preferably used as the component of the nitride semiconductor manufacturing apparatus.

(8) A second aspect of the present invention provides a device for cleaning a component of a nitride semiconductor manufacturing apparatus, having: a reaction chamber, which in addition to housing a component of a nitride semiconductor manufacturing apparatus to which has adhered deposits containing nitride semiconductor, is introduced with a cleaning gas containing a chlorine-based gas, a cooling chamber that houses the component of the nitride semiconductor manufacturing apparatus that has been subjected to chemical treatment with the cleaning gas containing a chlorine-based gas, and a spraying device housed in the cooling chamber that sprays a sublimable solid substance onto the component of the nitride semiconductor manufacturing apparatus.

(9) In (8) above, the cleaning device preferably has a heater that heats the inside of the reaction chamber.

(10) In (8) or (9) above, a device for cleaning a component of a nitride semiconductor manufacturing apparatus is provided that has an exhaust port that evacuates gas inside the reaction chamber.

(11) In any of (8) to (10) above, a device for cleaning a component of a nitride semiconductor manufacturing apparatus is provided that has a transfer portion arranged in opposition to the reaction chamber and the cooling chamber that transfers the component of the nitride semiconductor manufacturing apparatus from the reaction chamber to the cooling chamber between the reaction chamber and the cooling chamber.

(12) In any of (8) to (11) above, the spraying device preferably has a nozzle portion that sprays the sublimable solid substance onto the component of the nitride semiconductor manufacturing apparatus, and a solid substance formation portion that is integrated into a single unit with the nozzle portion, is introduced with a sublimable gas and a carrier gas from separate introduction ports, and forms the sublimable solid substance.

(13) In any of (8) to (12) above, the sublimable solid substance is preferably dry ice.

(14) In (1) above, the step in which chemical treatment is carried out is a step for removing at least a portion of the deposits by chemically treating a component of a nitride semiconductor manufacturing apparatus to which deposits containing nitrogen semiconductor have adhered with a cleaning gas containing a chlorine-based gas, and the step for removing the deposits is a step for removing at least a portion of the remaining deposits from the component of the nitride semiconductor manufacturing apparatus by spraying with a sublimable solid substance.

### Effects of the Invention

According to the method for cleaning components of a nitride semiconductor manufacturing apparatus of the present invention, as a result of chemically treating a component of a nitride semiconductor manufacturing apparatus to which deposits have adhered using a cleaning gas containing a chlorine-based gas, a reaction product is formed by a reaction between the deposits and the chlorine-based gas, and as a result of vaporizing the reaction product, the deposits can be removed from the component of the nitride semiconductor manufacturing apparatus.

In addition, by spraying a sublimable solid substance onto the deposits on the component of the nitride semiconductor manufacturing apparatus following chemical treatment, the deposits can be removed by impacts during collision with dry ice and expansion energy generated during sublimation while suppressing damage to the surface of the component of the nitride semiconductor manufacturing apparatus to within a range that sufficiently allows the component of the nitride semiconductor manufacturing apparatus to be reused.

Furthermore, in the present invention, a “plurality” refers to an arbitrary number of at least two.

### BRIEF DESCRIPTION OF DRAWINGS

FIG. 1 is a cross-sectional view showing the general configuration of a device for cleaning components of a nitride semiconductor manufacturing apparatus according to an embodiment of the present invention.

FIG. 2 is a photograph of the surface of a reactor component adhered with deposits of an MOCVD apparatus.

FIG. 3 is a photograph of the surface of a reactor component during cleaning with dry ice.

FIG. 4 is a photograph of the surface of a reactor component following completion of cleaning with dry ice.

FIG. 5 is a graph indicating changes in the amount of aluminum residue resulting from blasting with dry ice.

### DESCRIPTION OF EMBODIMENTS

The following provides a detailed explanation of preferred examples of embodiments to which the present invention is applied with reference to the drawings. Furthermore, drawings used in the following explanation are provided for explaining the configuration of embodiments of the present invention. The present invention is not limited to only these examples. The size, thickness, dimensional locations or quantities and the like of each portion shown in the drawings may differ from the dimensional relationships of an actual device for cleaning components of a nitride semiconductor manufacturing apparatus.

### Embodiments

The present invention relates to a method for cleaning components of a nitride semiconductor manufacturing apparatus to which have adhered deposits containing nitride semiconductor, and to a device for cleaning components of a nitride semiconductor manufacturing apparatus.

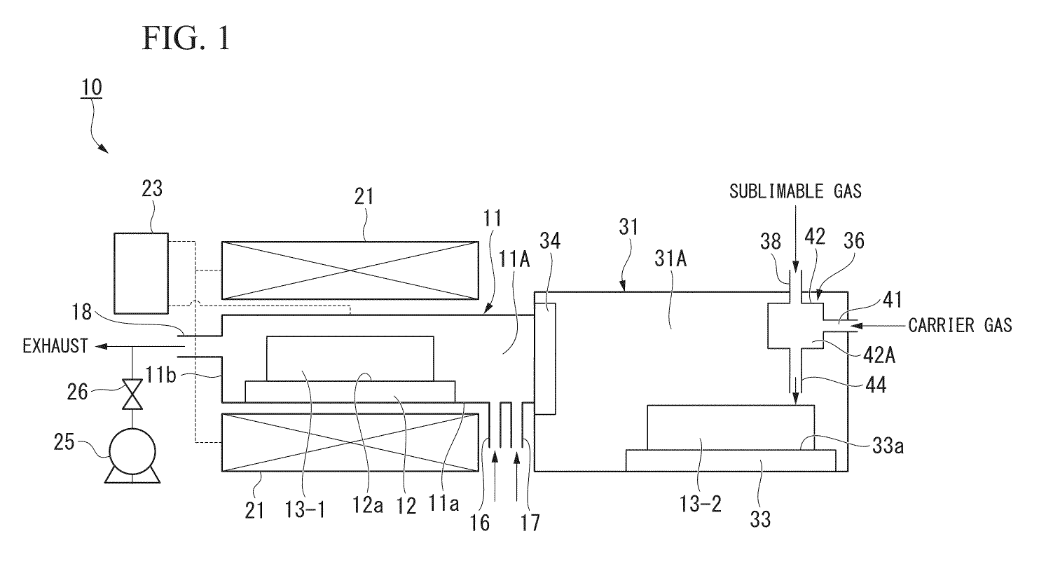

FIG. 1 is a cross-sectional view showing the general configuration of a device for cleaning components of a nitride semiconductor manufacturing apparatus according to an embodiment of the present invention.

With reference to FIG. 1, a device 10 for cleaning components of a nitride semiconductor manufacturing apparatus of the present embodiment (to also be simply referred to as the “cleaning device 10”) has a reaction chamber 11, a first nitride semiconductor manufacturing device component mounting stand 12, a first cleaning gas introduction port 16, a second cleaning gas introduction port 17, an exhaust port 18, heaters 21, a temperature controller 23, a vacuum pump 25, a valve 26, a cooling chamber 31, a second nitride semiconductor manufacturing apparatus component mounting stand 33, a transfer portion 34 and a spraying device 36.

The reaction chamber 11 has a space 11A that houses a nitride semiconductor manufacturing apparatus component 13 having deposits adhered thereto and the first nitride semiconductor manufacturing apparatus component mounting stand 12 therein.

In the reaction chamber 11, chemical treatment is carried out on the nitride semiconductor manufacturing apparatus component 13 having deposits adhered thereto using a cleaning gas containing a chlorine-based gas. An example of the nitride semiconductor manufacturing apparatus component 13 is a gas flow path component.

The first nitride semiconductor manufacturing apparatus component mounting stand 12 is housed in the reaction chamber 11. The first nitride semiconductor manufacturing apparatus component mounting stand 12 has a mounting surface 12a in the form of a flat surface on which the nitride semiconductor manufacturing apparatus component 13 having deposits adhered thereto is placed.

The first and second cleaning gas introduction ports 16 and 17 are provided in a bottom plate 11a of the reaction chamber 11 and are connected with the space 11A within the reaction chamber 11.

After placing the component 13 on the mounting stand 12, the first cleaning gas introduction port 16 introduces a cleaning gas in the form of a chlorine-based gas composed of at least one type among chlorine, hydrogen chloride and boron trichloride.

The use of chlorine for the first cleaning gas was determined to result in the least amount of deposits remaining on the nitride semiconductor manufacturing apparatus component 13 following chemical treatment. This is because chlorine has the highest reactivity among chlorine, hydrogen chloride and boron trichloride. High reactivity (short reaction time) results in improved cleaning efficiency. In addition, hydrogen chloride can also be expected to demonstrate effects similar to those of chlorine depending on the concentration to which it is diluted.

In addition, the reason for not using a fluorine-based gas or bromine-based gas for the first cleaning gas is that, since quartz is frequently used for the nitride semiconductor manufacturing apparatus component 13 (component targeted for cleaning in the present application), a fluorine-based gas in particular causes damage to the component.

In addition, the second cleaning gas introduction port 17 introduces at least one type of diluent gas among nitrogen, argon, helium and air into the space 11A within the reaction chamber 11.

Treatment may be carried out with the reaction chamber sealed, or treatment may be carried out while continuously allowing gas to flow into the reaction chamber. Furthermore, the first cleaning gas and the second cleaning gas may be separately introduced into the reaction chamber or may be introduced into the reaction chamber after mixing. In the case of introducing separately, the order in which they are introduced can be selected as necessary. The mixing ratio of the chlorine-based gas and cleaning gas can be selected as necessary. In addition, the cleaning gas and chlorine-based gas can be selected as necessary in the present invention.

The exhaust port 18 is provided in a sidewall 11b of the reaction chamber 11 and is connected with the space 11A within the reaction chamber 11. Cleaning gas is evacuated as necessary after being used in the chemical treatment of the present invention.

The heaters 21 are arranged above and below the reaction chamber 11. The heaters 21 heat the reaction chamber 11 so that the temperature of the nitride semiconductor manufacturing apparatus component 13 housed in the space 11A of the reaction chamber 11 is within the range of 500° C. to 1000° C. In addition, although the temperature can be selected as necessary, the temperature is more preferably 800° C. to 1000° C. Furthermore, although heating is carried out as necessary, heating is preferable for allowing chemical treatment to proceed efficiently.

The temperature controller 23 is arranged outside the reaction chamber 11. The temperature controller 23 employs a configuration in which, in addition to being electrically connected to the heaters 21, enables it to monitor the temperature of the reaction chamber 11. Although cleaning time can be selected as necessary, it is normally about 120 minutes.

The temperature controller 23 controls the temperature of the nitride semiconductor manufacturing apparatus component 13 having deposits adhered thereto to a preset temperature (and more specifically, to a prescribed temperature within the range of 500° C. to 1000° C.).

The vacuum pump 25 is connected to the exhaust port 18 through the valve 26. The vacuum pump 25 evacuates air and the like that has entered the reaction chamber 11 accompanying introduction of the nitride semiconductor manufacturing apparatus component 13 having deposits adhered thereto into the reaction chamber 11. In addition, the vacuum pump 25 evacuates cleaning gas remaining in the space 11A following completion of chemical treatment with the cleaning gas containing a chlorine-based gas (gas resulting from diluting the chlorine-based gas with diluent gas). Subsequently, the evacuated air and cleaning gas are released into the atmosphere after having been detoxified by a detoxifying device not shown.

In this manner, as a result of the cleaning device having the exhaust port 18 provided in the reaction chamber 11 and the vacuum pump 25 that evacuates gas (toxic gas containing cleaning gas and air) through the exhaust port 18, toxic gas remaining in the space 11A following chemical treatment can be efficiently evacuated outside the reaction chamber 11.

The cooling chamber 31 has a space 31A that houses the nitride semiconductor manufacturing apparatus component 13 that has been subjected to chemical treatment with cleaning gas containing a chlorine-based gas.

The cooling chamber 31 is arranged in opposition to the sidewall of the reaction chamber 11 located on the opposite side from the sidewall 11b where the exhaust port 18 is formed. A sidewall of the cooling chamber 31 contacts a sidewall of the reaction chamber 11.

The second nitride semiconductor manufacturing apparatus component mounting stand 33 is housed within the cooling chamber 31. The second nitride semiconductor manufacturing apparatus component mounting stand 33 has a mounting surface 33a in the form of a flat surface on which is placed the chemically treated nitride semiconductor manufacturing apparatus component 13.

The second nitride semiconductor manufacturing apparatus component mounting stand 33 is cooled by a cooling mechanism not shown. As a result, the nitride semiconductor manufacturing apparatus component 13 placed on the mounting stand 33a is cooled as necessary.

The transfer portion 34 is provided between the reaction chamber 11 and the cooling chamber 31. The transfer portion 34 is a member for transferring the nitride semiconductor manufacturing apparatus component 13 from the reaction chamber 11 to the cooling chamber 31. The transfer portion 34 can employ a configuration having, for example, a shutter mechanism not shown and a transport arm not shown (arm for transporting the nitride semiconductor manufacturing apparatus component 13).

In this manner, as a result of providing the transfer portion 34 that transfers the nitride semiconductor manufacturing apparatus component 13 from the reaction chamber 11 to the cooling chamber 31 between the reaction chamber 11 and the cooling chamber 31, the chemically treated nitride semiconductor manufacturing apparatus component 13 can be easily transferred to the cooling chamber 31.

In addition, the chemically treated nitride semiconductor manufacturing apparatus component 13 can be transferred in a shorter period of time to the cooling chamber 31 in comparison with the case of not providing the transfer portion 34 between the reaction chamber 11 and the cooling chamber 31. Accordingly, throughput of the cleaning step of the nitride semiconductor manufacturing apparatus component 13 can be improved.

The spraying device 36 has a sublimable gas introduction port 38, a carrier gas introduction port 41, a solid substance formation portion 42 and a nozzle portion 44.

The sublimable gas introduction port 38 is provided in the solid substance formation portion 42, and supplies sublimable gas to a space 42A formed within the solid substance formation portion 42.

In the present embodiment, a “sublimable gas” refers to a gas that undergoes a phase change directly from a solid to a gas at normal temperature and normal pressure. Examples of the aforementioned sublimable gas used include carbon dioxide gas and naphthalene.

Furthermore, the case of using carbon dioxide gas for the sublimable gas is used as an example in the subsequent explanations.

The carrier gas introduction port 41 is provided in the solid substance formation portion 42 and supplies carrier gas to the space 42A. Nitrogen, for example, can be used for the aforementioned carrier gas.

Furthermore, the case of using nitrogen for the carrier gas is used as an example in the subsequent explanations.

The solid substance formation portion 42 forms a sublimable solid substance in the form of dry ice within the space 42A due to a reaction between carbon dioxide gas (sublimable gas) introduced from the sublimable gas introduction port 38 and nitrogen (carrier gas) introduced from the carrier gas introduction port 41. The method used to form the dry ice and the like can be selected as necessary, and an ordinary method such as spraying compressed carbon dioxide gas into the carrier gas may be used.

Furthermore, the sublimable solid substance is not limited to dry ice provided it is a substance that at least contains carbon dioxide.

In addition, the dry ice may be preliminarily formed into pellets and then introduced from the sublimable gas introduction port 38, and nitrogen may be introduced from the carrier gas introduction port 41.

The nozzle portion 44 is provided on the lower end of the solid substance formation portion 42, and is arranged so as to oppose the chemically treated nitride semiconductor manufacturing apparatus component 13 having deposits remaining thereon. The nozzle portion 44 sprays dry ice onto the nitride semiconductor manufacturing apparatus component 13 that has undergone chemical treatment and has deposits remaining thereon.

According to the device for cleaning components of a nitride semiconductor manufacturing apparatus of the present embodiment, the device has the reaction chamber 11, which in addition to housing the nitride semiconductor manufacturing apparatus component 13 to which have adhered deposits containing nitride semiconductor, is introduced with cleaning gas containing a chlorine-based gas, the cooling chamber 31 that houses the nitride semiconductor manufacturing apparatus component 13 that has been chemically treated with a cleaning gas containing a chlorine-based gas, and a spraying device 36 housed within the cooling chamber 31 that sprays a sublimable solid substance onto the nitride semiconductor manufacturing apparatus component 13 having deposits adhered thereto. As a result, deposits can be removed from the nitride semiconductor manufacturing apparatus component 13 by chemically treating the nitride semiconductor manufacturing apparatus component 13 having deposits adhered thereto using a cleaning gas containing a chlorine-based gas, and vaporizing a reaction product formed by a reaction between the deposits and chlorine-based gas.

In addition, deposits remaining on the nitride semiconductor manufacturing apparatus component 13 can be removed by impacts during collision with dry ice and expansion energy generated during sublimation while suppressing damage to the surface of the nitride semiconductor manufacturing apparatus component 13 to within a range that sufficiently allows the components of the nitride semiconductor manufacturing apparatus to be reused by spraying a sublimable solid substance in the form of dry ice onto the deposits. Examples of deposits include carbon and at least one type of oxygen-containing metal oxide selected from the group consisting of aluminum nitride, gallium nitride, alumina, Ga, In, Al and Mg.

The following provides an explanation of the method for cleaning components of a nitride semiconductor manufacturing apparatus according to the present embodiment in the case of using the device 10 for cleaning components of a nitride semiconductor manufacturing apparatus shown in FIG. 1.

First, the nitride semiconductor manufacturing apparatus component 13 having deposits adhered thereto is placed on the mounting stand 12a of the first nitride semiconductor manufacturing device component mounting stand 12 within the reaction chamber 11.

Next, the reaction chamber 11 is heated by the heaters 21 so that the temperature of the nitride semiconductor manufacturing apparatus component 13 reaches a prescribed temperature within the range of 500° C. to 1000° C.

Next, a chlorine-based gas composed of at least one type among chlorine gas, hydrogen chloride and boron trichloride is introduced as cleaning gas into the space 11A of the reaction chamber 11 through the first cleaning gas introduction port 16. In combination therewith, a diluent gas composed of at least one type among nitrogen, argon, helium and air is introduced as cleaning gas into the space 11A of the reaction chamber 11 through the second cleaning gas introduction port 17. These gases are preferably used independently, and nitrogen alone is preferably used for the diluent gas (second cleaning gas). Furthermore, when two or more types are used in combination, the two types of nitrogen and argon are preferably used in combination.

As a result, deposits can be removed from the nitride semiconductor manufacturing apparatus component 13 as a result of vaporizing the reaction product formed by the reaction between the deposits and the chlorine-based gas by chemically treating the nitride semiconductor manufacturing apparatus component 13 having deposits adhered thereto with the chlorine-based gas and diluent gas.

Next, the cleaning gas containing the chlorine-based gas (gas obtained by diluting the chlorine-based gas with the diluent gas) is evacuated through the exhaust port 18 following the aforementioned chemical treatment.

Next, after having adequately evacuated the space 11A within the reaction chamber 11, the reaction chamber 11 and the transfer portion 34 are communicated (by opening a shutter composing the transfer portion 34 not shown), and the nitride semiconductor manufacturing apparatus component 13 that has been chemically treated and on which deposits remain is placed on the mounting surface 33a of the second nitride semiconductor manufacturing apparatus component mounting stand 33.

Next, the chemically treated nitride semiconductor manufacturing apparatus component 13 is cooled by a cooling mechanism (not shown) of the second nitride semiconductor manufacturing apparatus component mounting stand 33 so that the temperature thereof is within the range of room temperature to 50° C. In the case the device for cleaning the nitride semiconductor manufacturing apparatus component 13 is installed at a location such as a clean room where the room temperature thereof is controlled, the room temperature referred to here is about 25° C.

Next, a sublimable solid substance in the form of dry ice is formed by supplying a sublimable gas in the form of carbon dioxide gas and a carrier gas in the form of nitrogen gas to the space 42A formed within the solid substance formation portion 42 of the spraying device 36.

Next, deposits can be removed by impacts during collision with dry ice and expansion energy generated during sublimation by spraying dry ice onto the nitride semiconductor manufacturing apparatus component 13 that has been chemically treated and on which deposits remain from the nozzle portion 44 of the spraying device 36. Furthermore, the spraying device may be a movable device or only the nozzle portion may be a movable nozzle as necessary.

According to the method for cleaning components of a nitride semiconductor manufacturing apparatus of the present invention, as a result of chemically treating the nitride semiconductor manufacturing apparatus component 13 having deposits adhered thereto using a cleaning gas containing a chlorine-based gas, a reaction product is formed by a reaction between the deposits and the chlorine-based gas, and as a result of vaporizing the aforementioned reaction product, deposits can be removed from the nitride semiconductor manufacturing apparatus component 13.

In addition, as a result of spraying a sublimable solid substance onto deposits remaining on the nitride semiconductor manufacturing apparatus component 13 following chemical treatment, deposits can be removed by impacts during collision with dry ice and expansion energy generated during sublimation.

Depending on differences in the type and amount of deposits and other conditions, there are cases in which deposits adhered to the nitride semiconductor manufacturing apparatus component 13 may be unable to be completely removed by chemical treatment, as well as cases in which they can be nearly completely removed.

In the case deposits are unable to be completely removed by chemical treatment, the deposits are frequently strongly adhered to the surface of the nitride semiconductor manufacturing apparatus component 13. Deposits in this case are, for example, aluminum nitride (AlN), alumina or metal oxides in which they are contained.

Aluminum nitride and alumina, for example, have high activation energy, while metal oxides containing these substances contain components having high activation energy. The activation energy of aluminum nitride, for example, is about 0.6 eV.

In the case of being able to nearly completely remove deposits by chemical treatment, the deposits on the nitride semiconductor manufacturing apparatus component 13 are frequently weakly adhered to the component 13 in a thin layer thereof. Examples of deposits in this case include gallium nitride (GaN) and metal oxides containing gallium nitride. The activation energy of gallium nitride is lower than that of aluminum nitride or alumina, and metal oxides containing gallium nitride contain components having low activation energy. The activation energy of gallium nitride, for example, is about 0.23 eV.

In this manner, there is a correlation between activation energy prior to accumulation of deposits and the degree to which deposits accumulate on the nitride semiconductor manufacturing apparatus component 13 (degree of adhesion). The aforementioned correlation is such that the degree of adhesion increases as the activation energy prior to accumulation of deposits becomes higher. In addition, although components having a low degree of adhesion can be removed by chemical treatment, components having a high degree of adhesion cannot be removed by chemical treatment.

The method for cleaning components of a nitride semiconductor manufacturing apparatus of the present invention is particularly useful in the case of being unable to completely remove deposits by chemical treatment. Even if deposits are strongly adhered to the surface of the nitride semiconductor manufacturing apparatus component 13, deposits can be removed by first subjecting the nitride semiconductor manufacturing apparatus component 13 to chemical treatment followed by spraying with a sublimable solid substance. This is because as a result of removing deposits containing components having comparatively low activation energy formed between the deposits and the nitride semiconductor manufacturing apparatus component 13 by chemical treatment, extremely small gaps are formed between the deposits and the surface of the nitride semiconductor manufacturing apparatus component 13 that enable efficient utilization of the energy of collisions with the sublimable solid substance (dry ice) and expansion energy resulting from sublimation. For example, even if deposits in the form of a metal oxide containing aluminum nitride having activation energy of 0.6 eV are strongly adhered at a thickness of about 300 nm to 500 nm, these deposits can be removed by the method for cleaning components of a nitride semiconductor manufacturing apparatus of the present invention.

When removing deposits with dry ice, damage to the surface of the nitride semiconductor manufacturing apparatus component 13 is suppressed to a range that sufficiently allows the nitride semiconductor manufacturing apparatus component 13 to be reused.

The range over which surface damage can be allowed is a maximum roughness of the nitride semiconductor manufacturing apparatus component 13 of 1 μm. In other words, cleaning of the nitride semiconductor manufacturing apparatus component 13 in the present invention can be carried out up to a maximum roughness of 1 μm.

Thus, deposits adhered to the surface of the nitride semiconductor manufacturing apparatus component 13 can be precisely removed. Although the dry ice spraying pressure can be selected as necessary, it is normally 0.05 MPa to 0.06 MPa and preferably 0.05 MPa to 0.15 MPa. In addition, although the distance between the nozzle portion and the component 13 can be selected as necessary, it is normally 5 mm to 100 mm and preferably 10 mm to 50 mm.

In addition, the nitride semiconductor manufacturing apparatus component 13 is frequently made of a material such as quartz. Thus, if the collision and expansion energy when spraying the sublimable solid substance are excessively high, the component ends up being scratched or damaged. However, since the sublimable solid substance ends up being eliminated as a result of sublimation, deposits can be removed without damaging the nitride semiconductor manufacturing apparatus component 13.

The above has provided a description of preferred embodiments of the present invention. The present invention is not limited to these specific embodiments, but rather can be altered and modified in various ways within the scope of the gist of the present invention as described in the claims.

### EXAMPLE 1

A reactor component (nitride semiconductor manufacturing apparatus component 13) having deposits adhered thereto of a metal organic chemical vapor deposition (MOCVD) apparatus (nitride semiconductor manufacturing apparatus) was chemically treated using hydrogen chloride (cleaning gas containing a chlorine-based gas). Subsequently, dry ice was sprayed onto the aforementioned reactor component having deposits adhered thereto and subjected to chemical treatment while gradually increasing the pressure to determine the pressure at which the deposits are able to be removed. The pressure that enabled removal was 0.5 MPa.

Next, a quartz wafer not having deposits adhered thereto was prepared, and surface roughness of the aforementioned quartz wafer was measured using a surface roughness tester (such as a compact surface roughness tester in the form of a member of the Surf Test SJ-210 series manufactured by Mitutoyo Corp.). The result is shown in Table 1.

When measuring surface roughness, surface roughness was measured at a total of 12 locations consisting of 3 locations at equal intervals in the radial direction of the aforementioned quartz wafer and 4 locations at equal intervals in the circumferential direction of the aforementioned quartz wafer.

The sample of Example 1 was fabricated by spraying the aforementioned dry ice at a pressure of 0.5 MPa (gauge pressure) onto the surface of the aforementioned quartz wafer. Subsequently, the surface roughness of the sample of Example 1 in the form of the aforementioned quartz wafer was measured. The result is shown in Table 1.

When measuring surface roughness, surface roughness was measured at a total of 12 locations consisting of 3 locations at equal intervals in the radial direction of the aforementioned quartz wafer and 4 locations at equal intervals in the circumferential direction of the aforementioned quartz wafer.

TABLE 1

| Surface roughness before dry | Surface roughness after dry |
|---|---|
| ice treatment (RA: μm) | ice treatment (RA: μm) |
| 0.035 to 0.064 | 0.035 to 0.071 |

With reference to Table 1, surface roughness of the quartz wafer before dry ice treatment was 0.035 to 0.064 μm, while surface roughness of the quartz wafer after dry ice treatment was 0.035 to 0.071 μm.

On the basis thereof, the quartz wafer was able to be confirmed to not be damaged by dry ice treatment at a pressure that enables removal of deposits.

### EXAMPLE 2

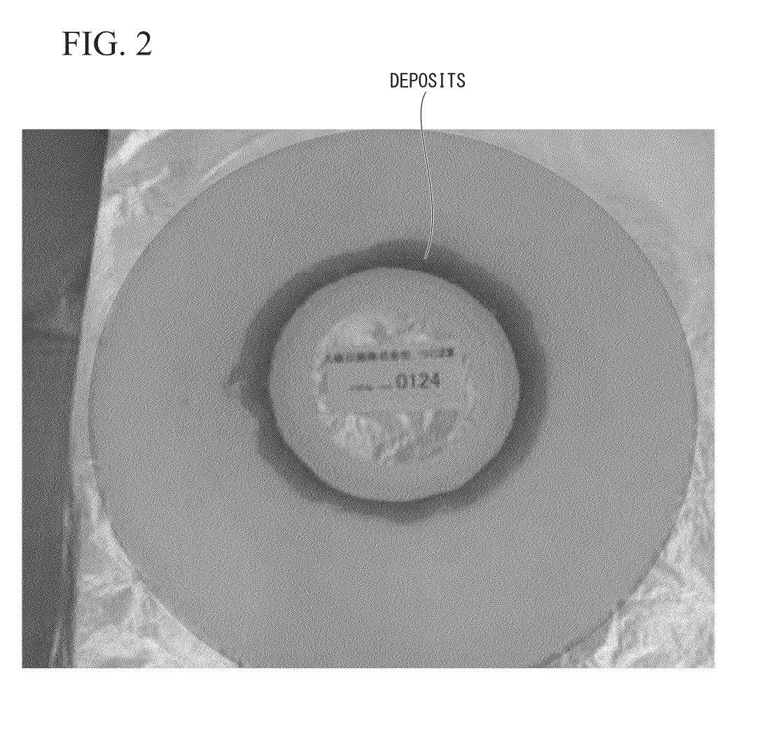

A reactor component of an MOCVD apparatus having deposits adhered thereto was prepared and a photograph was taken of the surface of the aforementioned reactor component. That photograph is shown in FIG. 2. FIG. 2 is a photograph of the surface of a reactor component adhered with deposits of an MOCVD apparatus.

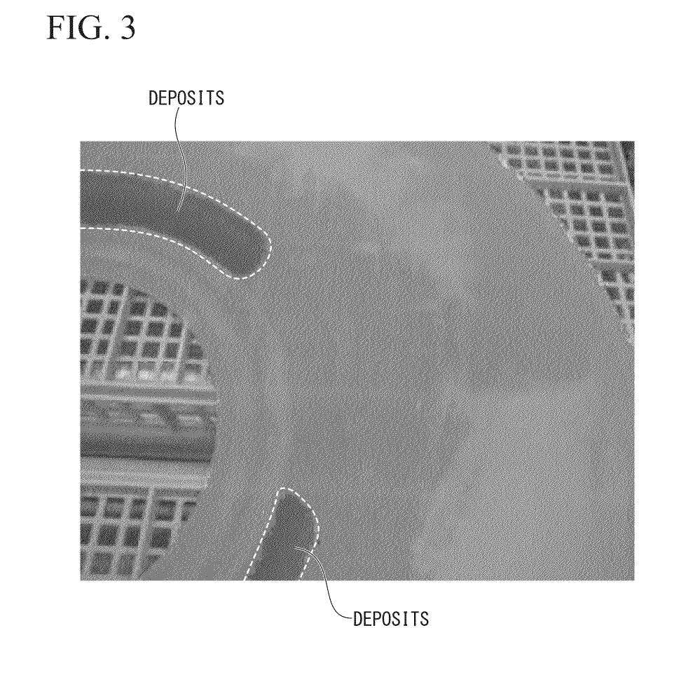

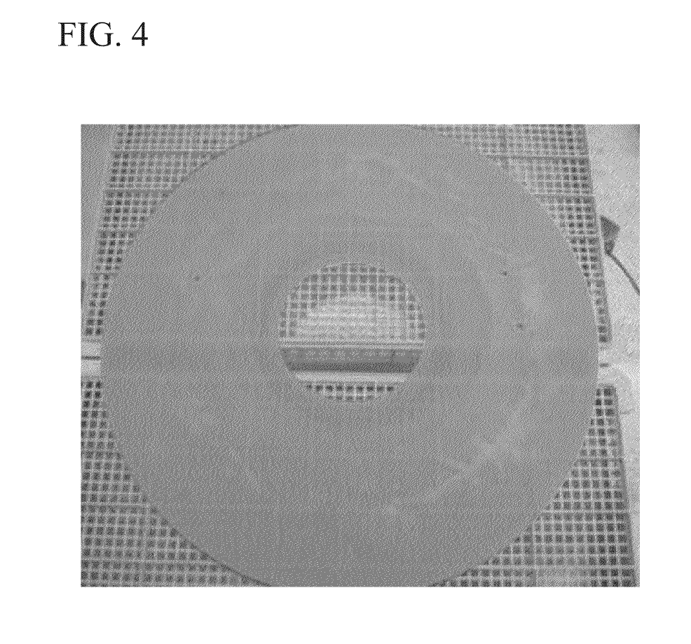

Next, chemical treatment was carried out using hydrogen chloride (cleaning gas containing a chlorine-based gas) followed by spraying dry ice at a pressure of 0.5 MPa (gauge pressure) onto the reactor component having deposits adhered thereto following chemical treatment. A photograph of the surface of the reactor component during cleaning with dry ice is shown in FIG. 3, and a photograph of the surface of the reactor component following completion of cleaning with dry ice is shown in FIG. 4. FIG. 3 is a photograph of the surface of a reactor component during cleaning with dry ice. FIG. 4 is a photograph of the surface of a reactor component following completion of cleaning with dry ice.

With reference to FIGS. 3 and 4, deposits were able to be confirmed to be precisely removed from the surface of the reactor component by carrying out cleaning with dry ice.

### EXAMPLE 3

A reactor component (nitride semiconductor manufacturing apparatus component 13) having deposits adhered thereto of a metal organic chemical vapor deposition (MOCVD) apparatus (nitride semiconductor manufacturing apparatus) was chemically treated using chlorine (cleaning gas containing a chlorine-based gas). Subsequently, a step for removing the deposits (dry ice treatment) was carried out by spraying dry ice for 10 seconds at a pressure (gauge pressure) of 0.15 MPa onto the aforementioned reactor component having deposits adhered thereto following chemical treatment.

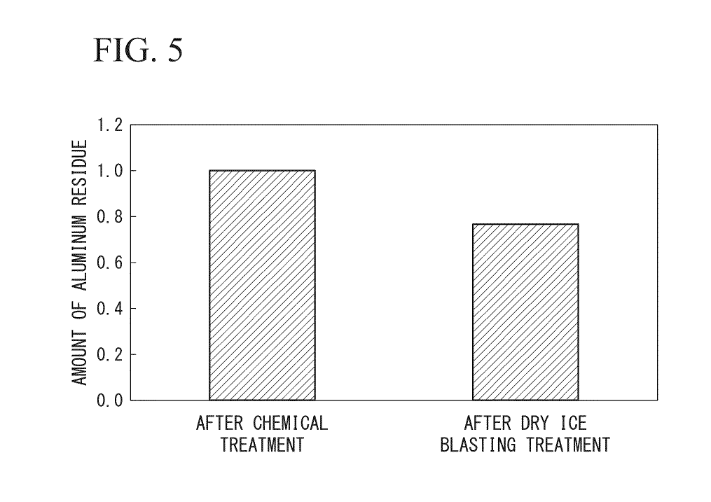

FIG. 5 shows the results of measuring the amounts of aluminum residue before and after dry ice blasting treatment by X-ray fluorescence analysis. According to these results, 22% of the aluminum residue was able to be removed based on the amount present prior to treatment as a result of dry ice blasting treatment.

### INDUSTRIAL APPLICABILITY

The present invention can be applied to a method for cleaning components of a nitride semiconductor manufacturing apparatus, and a device for cleaning components of a nitride semiconductor manufacturing apparatus, capable of precisely removing deposits adhered to the surface of a component of a nitride semiconductor manufacturing apparatus. Moreover, the present invention is able to provide a method for cleaning components of a nitride semiconductor manufacturing apparatus, and a device for cleaning components of a nitride semiconductor manufacturing apparatus, capable of removing deposits by impacts during collision with dry ice and expansion energy generated during sublimation while suppressing damage to the surface of the component of the nitride semiconductor manufacturing apparatus to within a range that sufficiently allows the component of the nitride semiconductor manufacturing apparatus to be reused. DESCRIPTION OF REFERENCE SIGNS

10 Device for cleaning components of a nitride semiconductor manufacturing apparatus

11 Reaction chamber

11a Bottom plate

11b Sidewall

11A, 31A, 42A Space

12 First nitride semiconductor manufacturing device component mounting stand

12a, 33a Mounting surface

13 Nitride semiconductor manufacturing apparatus Component

16 First cleaning gas introduction port

17 Second cleaning gas introduction port

18 Exhaust port

21 Heaters

23 Temperature controller

25 Vacuum pump

26 Valve

31 Cooling chamber

33 Second nitride semiconductor manufacturing device component mounting stand

34 Transfer portion

36 Spraying device

38 Sublimable gas introduction port

41 Carrier gas introduction port

42 Solid substance formation portion

44 Nozzle portion

1. A method for cleaning a component of a nitride semiconductor manufacturing apparatus to which has adhered deposits containing nitride semiconductor, comprising:
a step for chemically treating the component of the nitride semiconductor manufacturing apparatus with a cleaning gas containing a chlorine-based gas, and
a step for removing the deposits from the component of the nitride semiconductor manufacturing apparatus by spraying with a sublimable solid substance.

2. The method for cleaning a component of a nitride semiconductor manufacturing apparatus according to claim 1, wherein a mixed gas comprised of a mixture of at least one type of chlorine-based gas among chlorine, hydrogen chloride and boron trichloride, and
at least one type of diluent gas among nitrogen, argon, helium and air, is used for the cleaning gas.

3. The method for cleaning a component of a nitride semiconductor manufacturing apparatus according to claim 1, wherein the treatment temperature of the chemical treatment is within the range of 500° C. to 1000° C.

4. The method for cleaning a component of a nitride semiconductor manufacturing apparatus according to claim 3, wherein a component having low activation energy among the deposit components is removed in the chemical treatment step.

5. The method for cleaning a component of a nitride semiconductor manufacturing apparatus according to claim 1, wherein the sublimable solid substance at least contains carbon dioxide.

6. The method for cleaning a component of a nitride semiconductor manufacturing apparatus according to claim 5, wherein the sublimable solid substance is dry ice.

7. The method for cleaning a component of a nitride semiconductor manufacturing apparatus according to claim 1, wherein a gas flow path component is preferably used as the component of the nitride semiconductor manufacturing apparatus to be cleaned.

8. A device for cleaning a component of a nitride semiconductor manufacturing apparatus, having:
a reaction chamber, which in addition to housing a component of a nitride semiconductor manufacturing apparatus to which has adhered deposits containing nitride semiconductor, is introduced with a cleaning gas containing a chlorine-based gas,
a cooling chamber that houses the component of the nitride semiconductor manufacturing apparatus that has been subjected to chemical treatment with the cleaning gas containing a chlorine-based gas, and
a spraying device housed in the cooling chamber that sprays a sublimable solid substance onto the component of the nitride semiconductor manufacturing apparatus.

9. The device for cleaning a component of a nitride semiconductor manufacturing apparatus according to claim 8, having a heater that heats the inside of the reaction chamber.

10. The device for cleaning a component of a nitride semiconductor manufacturing apparatus according to claim 8, having an exhaust port that evacuates gas inside the reaction chamber.

11. The device for cleaning a component of a nitride semiconductor manufacturing apparatus according to claim 8, having a transfer portion arranged in opposition to the reaction chamber and the cooling chamber that transfers the component of the nitride semiconductor manufacturing apparatus from the reaction chamber to the cooling chamber between the reaction chamber and the cooling chamber.

12. The device for cleaning a component of a nitride semiconductor manufacturing apparatus according to claim 8, wherein the spraying device has a nozzle portion that sprays the sublimable solid substance onto the component of the nitride semiconductor manufacturing apparatus, and a solid substance formation portion that is integrated into a single unit with the nozzle portion, is introduced with a sublimable gas and a carrier gas from separate introduction ports, and forms the sublimable solid substance.

13. The device for cleaning a component of a nitride semiconductor manufacturing apparatus according to claim 8, wherein the sublimable solid substance is dry ice.

14. The method for cleaning a component of a nitride semiconductor manufacturing apparatus according to claim 1, wherein the step in which the chemical treatment is carried out is a step for removing at least a portion of the deposits by chemically treating a component of a nitride semiconductor manufacturing apparatus to which deposits containing nitrogen semiconductor have adhered with a cleaning gas containing a chlorine-based gas, and
the step for removing the deposits is a step for removing at least a portion of the remaining deposits from the component of the nitride semiconductor manufacturing apparatus by spraying with a sublimable solid substance.
